(19) United States
(12) Patent Application Publication
(10) Pub. No.: US 2012/0154448 A1
(43) Pub. Date: Jun. 21, 2012

(54) IMAGE FORMING SYSTEM AND COMPUTER-READABLE RECORDING MEDIUM

(75) Inventors: Atsushi TOMITA, Toyohashi-shi (JP); Ryosuke Nishimura, Toyokawa-shi (JP); Takatsugu Kuno, Toyokawa-shi (JP); Kenichi Sawada, Toyohashi-shi (JP)

(73) Assignee: KONICA MINOLTA BUSINESS TECHNOLOGIES, INC., Chiyoda-ku (JP)

(21) Appl. No.: 13/315,517

(22) Filed: Dec. 9, 2011

(30) Foreign Application Priority Data
Dec. 16, 2010 (JP) 2010-280835

(51) Int. Cl. G09G 5/00

(52) U.S. Cl. 345/684

(57) ABSTRACT

An image forming system comprises a display control part, an instruction input part, and a notification control part. The display control part displays at least one of a plurality of buttons, which is included in a display target range, on a display part as display target buttons. The plurality of buttons corresponding to a plurality of functions, respectively, are virtually arranged in a predetermined direction. The instruction input part receives a scroll instruction input for causing the display target range to virtually move in the predetermined direction to change the display target buttons. The notification control part controls a notifying operation for notifying a user of the presence of the instruction input part.

This application is based on Japanese Patent Application No. 2010-280835 filed on Dec. 16, 2010, the contents of which are hereby incorporated by reference.

### BACKGROUND OF THE INVENTION

1. Field of the Invention

The present invention relates to an image forming system and a technique relevant to the same.

2. Description of the Background Art

In image forming apparatuses, as the number of functions which can be used in the apparatuses increases year by year, the number of buttons for settings, corresponding to these functions respectively, increases. Therefore, it is hard to display all the buttons corresponding to all the functions, respectively, on a display part. For this reason, there are techniques in which some of a plurality of buttons arranged in a predetermined direction are displayed as display target buttons on a display part and the display target buttons are changed by a scroll operation.

Japanese Patent Application Laid Open Gazette No. 2006-323504, for example, discloses a technique in which some of a plurality of buttons (icons) are displayed as display target buttons in a list display area and the display target buttons are changed (scrollingly displayed) by manipulating a scroll button.

In the technique of Japanese Patent Application Laid Open Gazette No. 2006-323504, however, it cannot be clearly seen from details displayed on a display screen whether the display target buttons can be changed (scrolled) or not. Therefore, there is a possibility that a user cannot notice even the presence of an instruction input part (scroll button or the like) which receives a scroll instruction input.

### SUMMARY OF THE INVENTION

It is an object of the present invention to provide a technique used for an image forming system in which some of a plurality of buttons are displayed as display target buttons, which enables a user to notice the presence of an instruction input part which receives a scroll instruction input for causing the display target buttons to be changed.

The present invention is intended for an image forming system. According to the present invention, the image forming system comprises a display control part for displaying at least one of a plurality of buttons, which is included in a display target range, on a display part as display target buttons, the plurality of buttons corresponding to a plurality of functions, respectively, being virtually arranged in a predetermined direction, an instruction input part for receiving a scroll instruction input for causing the display target range to virtually move in the predetermined direction to change the display target buttons, and a notification control part for controlling a notifying operation for notifying a user of the presence of the instruction input part.

The present invention is also intended for a non-transitory computer-readable recording medium. According to the present invention, the non-transitory computer-readable recording medium records therein a computer program for causing a computer to serve as a device comprising a display control part for displaying at least one of a plurality of buttons, which is included in a display target range, on a display part as display target buttons, the plurality of buttons corresponding to a plurality of functions, respectively, being virtually arranged in a predetermined direction, an instruction input part for receiving a scroll instruction input for causing the display target range to virtually move in the predetermined direction to change the display target buttons, and a notification control part for notifying a user of the presence of an operation member displayed on the display part and used for receiving the scroll instruction input.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram showing a schematic constitution of an image forming apparatus;

FIG. 2 is a view showing user authentication data;

FIGS. 3 to 6 are flowcharts showing an operation of the image forming apparatus;

FIG. 7 is a view showing a login screen;

FIG. 8 is a view showing an initial screen;

FIGS. 9 to 14 are views each showing a setting list screen; and

FIG. 15 is a view showing a schematic constitution of an image forming system in accordance with a variation.

### DESCRIPTION OF THE PREFERRED EMBODIMENTS

Hereinafter, the preferred embodiment of the present invention will be discussed with reference to the accompanying drawings.

<1. Constitution>

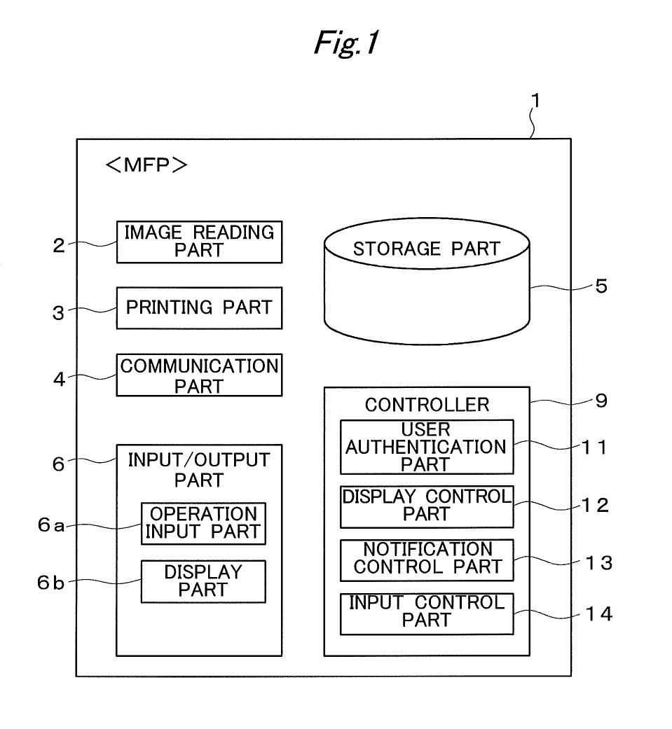

FIG. 1 is a schematic view showing a constitution of an image forming apparatus 1. Herein, the image forming apparatus 1 is configured as a Multi Function Peripheral (abbreviated as “MFP”). The MFP is an apparatus (also referred to as a “multifunction machine”) comprising a scanner function, a printer function, a copy function, a facsimile communication function and the like. Each image forming apparatus 1 is not limited to an MFP but may be configured as a copier, a scanner, or the like.

As shown in FIG. 1, the image forming apparatus 1 comprises an image reading part 2, a printing part 3, a communication part 4, a storage part 5, an input/output part 6, a controller 9, and the like and multiply uses these constituent parts to implement various functions.

The image reading part 2 is a processing part which optically reads an original manuscript placed on a predetermined position of the image forming apparatus 1 and generates image data of the original manuscript (referred to also as an “original manuscript image”).

The printing part 3 is an output part which prints out an image to various media such as paper on the basis of the image data on an object image.

The communication part 4 is a processing part capable of performing facsimile communication via public networks or the like. Further, the communication part 4 is capable of performing network communication via a network NW. The network communication uses various protocols such as TCP/IP (Transmission Control Protocol/Internet Protocol), FTP (File Transfer Protocol), and the like, and by using the network communication, the image forming apparatus 1 can transmit and receive various data to/from desired partners.

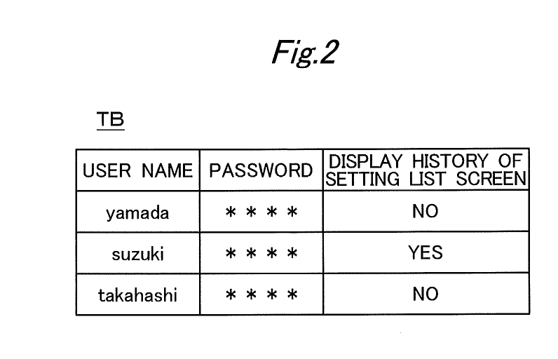

The storage part 5 is a storage device such as a hard disk drive (HDD), a nonvolatile memory, or/and the like. In the storage part 5, stored is user authentication data TB (see FIG. 2) to be used in a user authentication process (described later) or the like. In the user authentication data TB, recorded are various kinds of information of each user who is permitted to use the image forming apparatus 1.

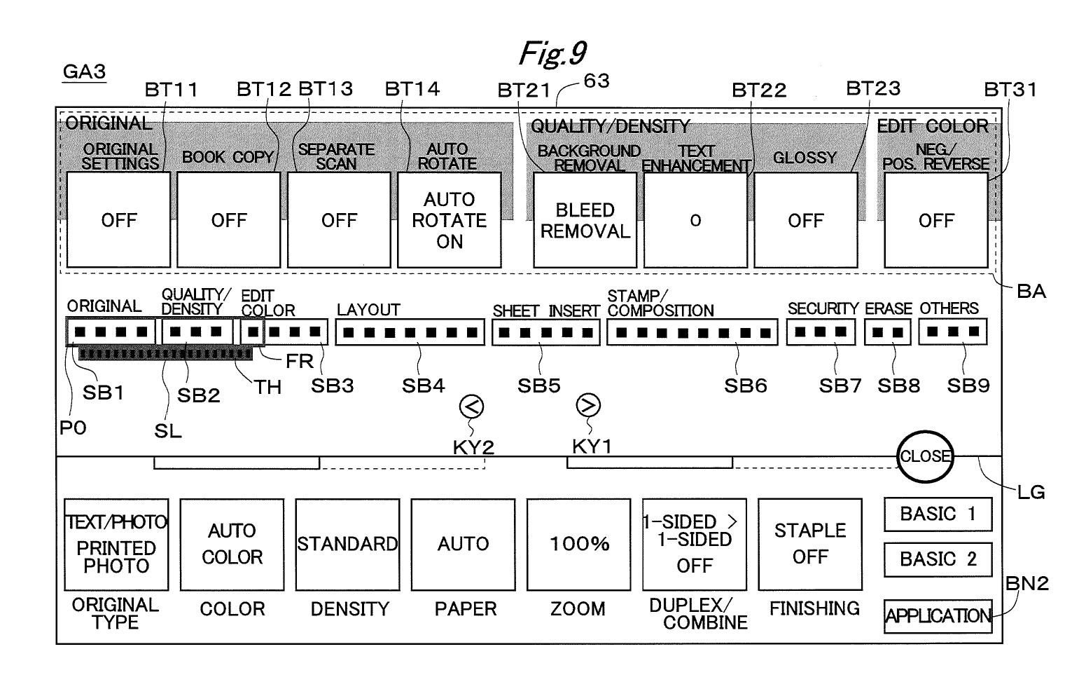

Specifically, as shown in FIG. 2, in the user authentication data TB, recorded are various kinds of information such as “User Name”, “Password”, and “Display History of Setting List Screen” of each user. As the “User Name” and the “Password”, recorded are authentication information on a target user. As the “Display History of Setting List Screen”, recorded is a display history of the setting list screen LG (described later) (see FIG. 9) associated with the target user (whether the screen has been displayed or not by the target user).

The input/output part 6 comprises an operation input part 6a for receiving an input which is given to the image forming apparatus 1 and a display part 6b for displaying various information thereon.

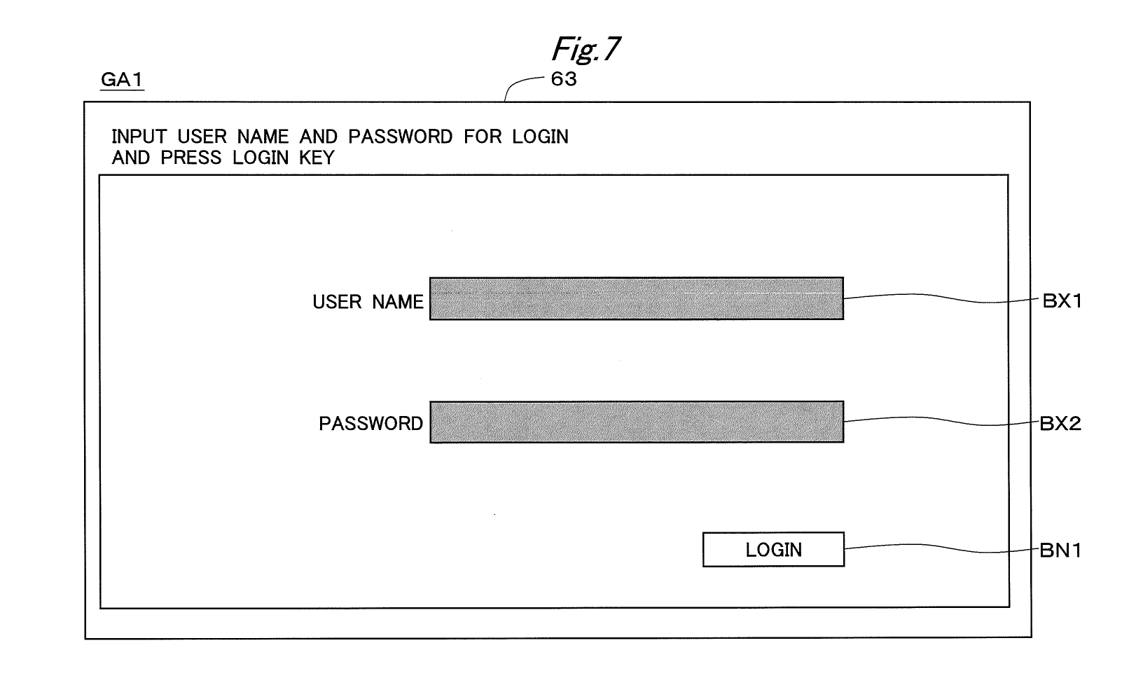

In more detail, the image forming apparatus 1 is provided with an operation panel part 60 (not shown) which serves as the input/output part 6. The operation panel part 60 has various hard keys and a touch screen 63 (see FIG. 7).

The touch screen 63 is a liquid crystal display panel in which a piezoelectric sensor or the like is embedded, serving as part of the display part 6b and also serving as part of the operation input part 6a. In more detail, the touch screen 63 is capable of displaying various information on the liquid crystal display panel and detecting a manipulation position of a finger of an operator on the liquid crystal display panel to receive various inputs. When the finger of the operator touches a virtual button displayed on the touch screen 63, for example, such a manipulation is regarded as a pressing operation on the virtual button.

Thus, the input/output part 6 is capable of receiving an input operation of the operator.

The controller 9 is a control part for generally controlling the image forming apparatus 1 and comprises a CPU and various semiconductor memories (RAM, ROM, and the like). Various processing parts operate under the control of the controller 9 to implement various functions of the image forming apparatus 1. The controller 9 causes the CPU to execute a predetermined software program (hereinafter, referred to simply as a “program”) PG stored in the ROM (e.g., EEPROM or the like), to thereby implement various processing parts. Further, the program PG may be acquired via various portable (in other words, non-transitory) computer-readable recording media (a USB memory or the like). Alternatively, the program PG may be downloaded via the network or the like and installed into the image forming apparatus 1.

Specifically, the controller 9 implements various processing parts including a user authentication part 11, a display control part 12, a notification control part 13, and an input control part 14.

The user authentication part 11 is a processing part for performing user authentication.

The display control part 12 is a processing part for controlling a display operation of displaying various screens or the like on the touch screen 63.

The notification control part 13 is a processing part for notifying a user of the presence of a slider, move instruction input keys KY1 and KY2, and the like in the setting list screen LG (described later).

The input control part 14 is a processing part for receiving an instruction input from the user. Specifically, the input control part 14 receives the instruction input from the user through operation members (the slider SL and the like) described later.

<2. Operation>

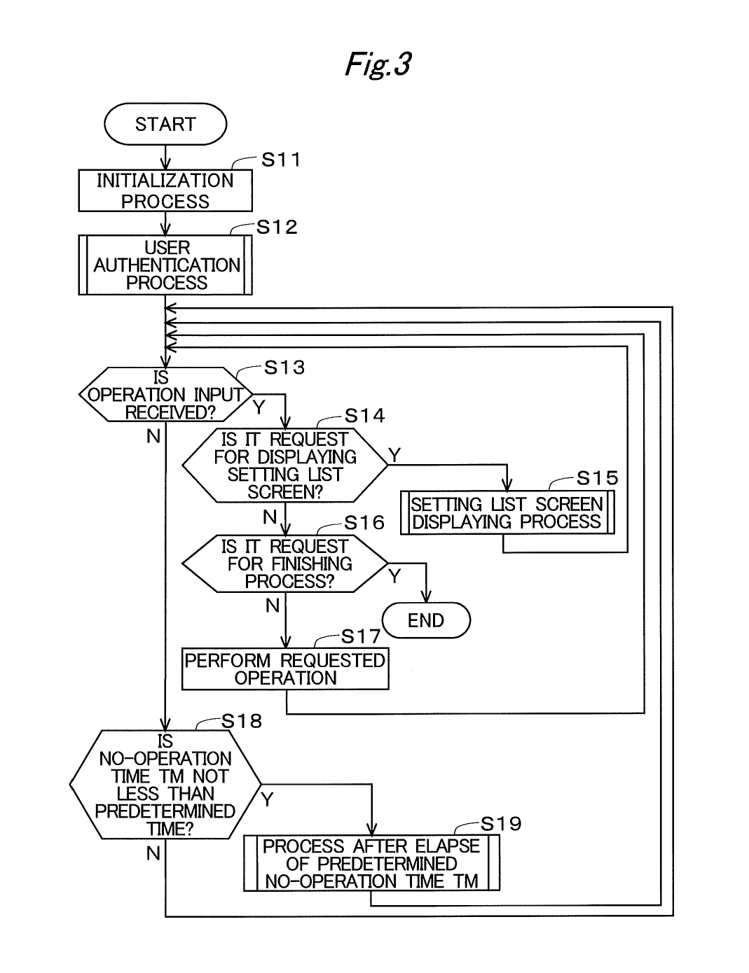

Detailed discussion will be made on an operation of the image forming apparatus 1 with reference to FIGS. 3 to 12.

FIGS. 3 to 6 are flowcharts showing an operation of the image forming apparatus 1. FIGS. 7 to 12 are views showing screens GA1 to GA6 displayed on the touch screen 63.

First, in Step S11 of FIG. 3, an initialization process (in which the memories are cleared, a standard mode is set, and so on) is performed by turning on the power of the image forming apparatus 1 or the like.

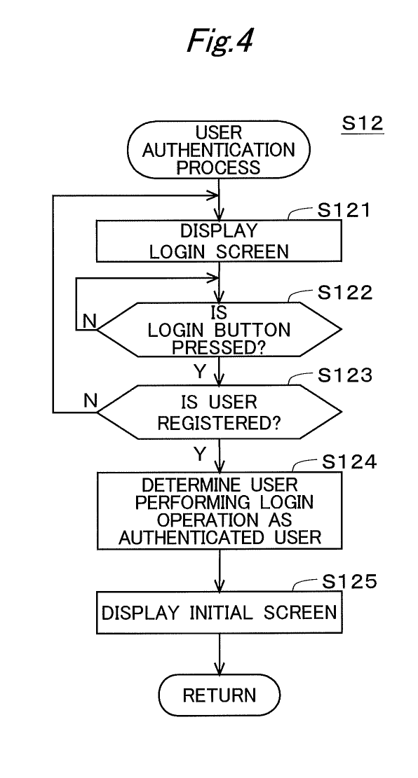

After the initialization process is completed, in Step S12, the image forming apparatus 1 performs a user authentication process (see FIG. 4).

Specifically, the image forming apparatus 1 performs an operation shown in the flowchart of FIG. 4.

First, the image forming apparatus 1 displays a login screen GA1 of FIG. 7 on the touch screen 63 (Step S121 in FIG. 4).

As shown in FIG. 7, in the login screen GA1, displayed are a box BX1 for inputting a user name and a box BX2 for inputting a password. A login button BN1 for giving an instruction for starting the user authentication is also displayed in the login screen GA1.

After the login screen GA1 is displayed, the image forming apparatus 1 goes into a state (referred to also as a “standby state WS1”) for waiting for a login operation of the user (in more detail, operations of inputting the user name and the password and pressing the login button BN1) (Step S122).

In the above standby state WS1, after the login operation is received, the user authentication part 11 performs the user authentication process (referred to also as a “login process”).

First, the user authentication part 11 determines whether the user is a registered user or not on the basis of the user name UN inputted in the box BX1 and the password PW inputted in the box BX2 (Step S123). In more detail, the user authentication part 11 determines whether or not data which coincides with the user name UN and the password PW is recorded in the user authentication data TB (see FIG. 2).

When the user authentication succeeds, the image forming apparatus 1 determines the user who performs the login operation, as an authenticated user CU (Step S124). On the other hand, when the user authentication fails, the image forming apparatus 1 does not determine the user who performs the login operation, as an authenticated user CU, and displays the login screen GA1 again (Step S121).

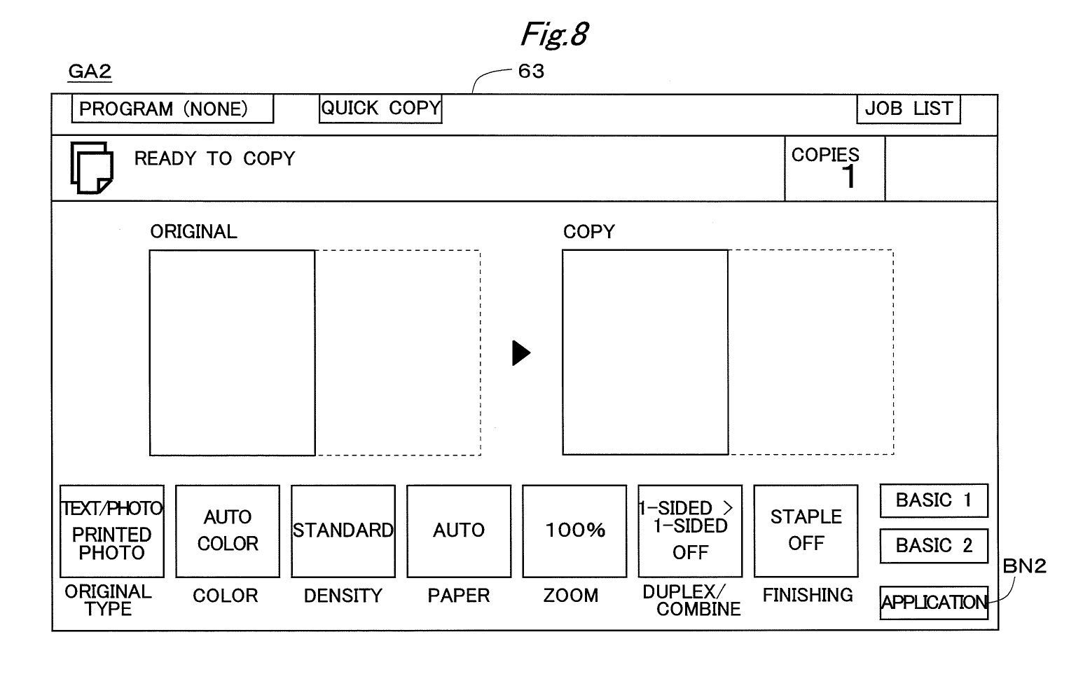

After the user who performs the login operation is determined as the authenticated user CU in Step S124, the display control part 12 displays an initial screen GA2 of FIG. 8 on the touch screen 63 (Step S125).

After the initial screen GA2 is displayed, the process goes to Step S13 (see FIG. 3). The following operation is performed during a period from Step S13 until a logout operation is completed (during an operation performed by the authenticated user).

In Step S13, it is determined whether any operation input is performed or not by the user (authenticated user CU) authenticated in Step S12. When it is determined that an operation input is performed by the user, the process goes to Step S14, and when it is not determined that an operation input is performed by the user, the process goes to Step S18.

In Step S18, it is determined whether or not a no-operation time TM (described later) is not less than a predetermined time (e.g., 5 seconds). Since measurement of the no-operation time TM starts after a notifying process NP (described later) is performed, the no-operation time TM is always an initial value (specifically, 0 second) before the notifying process NP is performed. Therefore, at the point in time, the no-operation time TM is always determined to be less than the predetermined time and the process returns to Step S13.

Specifically, before the notifying process NP is performed, the determinations of Step S13 and the Step S18 are repeatedly performed until the operation input from the user is received. In other words, the image forming apparatus 1 goes into a state (referred to also as a “standby state WS2”) for waiting for the operation input from the user.

On the other hand, when the operation input from the user is received in the standby state WS2, it is determined in Step S13 that the operation input is performed by the user, and the process goes to Step S14.

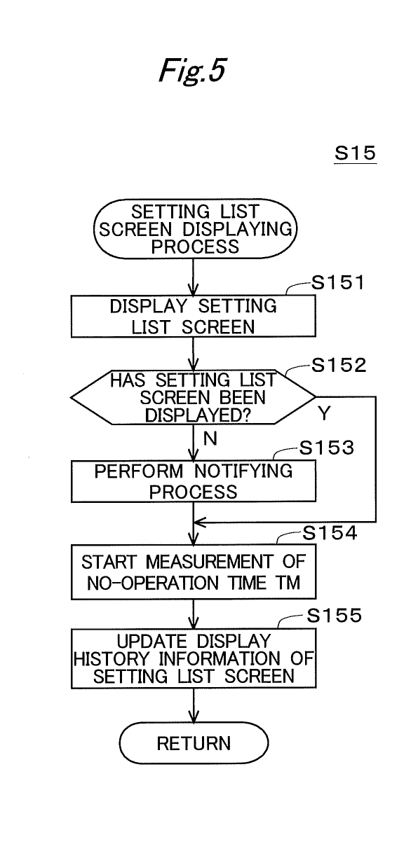

In Step S14, it is determined whether or not the operation input from the user is a request for displaying the setting list screen LG on the touch screen 63 (an operation of pressing an application setting button BN2 in the initial screen GA2 of FIG. 8). When it is determined that the operation input is the request for displaying the setting list screen LG, the process goes to Step S15 (the flowchart of FIG. 5), and when it is not determined that the operation input is the request for displaying the setting list screen LG, the process goes to Step S16.

Herein, discussion will be made first on an operation of Step S16 and the following steps, and then discussion will be made on an operation of Step S15 (the flowchart of FIG. 5).

In Step S16, it is determined whether or not the operation input from the user is a request for finishing the process (a request for logout or the like). When it is not determined that the operation input is the request for finishing the process, the process goes to Step S17, and when it is determined that the operation input is the request for finishing the process, the user is logged out from the image forming apparatus 1 and the process is completed.

In Step S17, the image forming apparatus 1 responds to the operation input from the user to perform a requested operation. As the requested operation, performed is, for example, an operation of copying an original manuscript, an operation of scanning the original manuscript, an operation of changing basic settings, or the like.

After the requested operation is performed, the process returns to Step S13, and the image forming apparatus 1 goes into the standby state WS2 again.

Subsequently, discussion will be made on an operation of Step S15 and the following steps.

In the above standby state WS2, when the application setting button BN2 in the initial screen GA2 of FIG. 8 is pressed, it is determined that the operation input is the request for displaying the setting list screen LG (Step S14), and the process goes to Step S15 (the process of the flowchart in FIG. 5).

In Step S151 of FIG. 5, the display control part 12 displays the setting list screen LG being superposed on a screen GA3 (see FIG. 9) on the touch screen 63. Specifically, the setting list screen LG pops up on the upper side of the screen GA3.

As shown in FIG. 9, a button display area BA is provided on the upper side in the setting list screen LG. In the button display area BA, some (BT11 to BT14, BT21 to BT23, BT31 in FIG. 9) of a plurality of function setting buttons BT corresponding to a plurality of functions, respectively, are arranged in the horizontal direction and displayed. In more detail, in the button display area BA, some (at least one) of the plurality of function setting buttons BT arranged virtually in a predetermined (herein, horizontal) direction, which are (is) included in a display target range, are displayed as display target buttons on the touch screen 63.

In the setting list screen LG, group bars SB (SB1, SB2, . . . , SB9) each including black squares therein are displayed below the button display area BA. The group bars SB (SB1, SB2, . . . , SB9) correspond to application set items (“Original”, “Quality/Density”, . . . , “Others”), respectively.

The black squares in the group bars SB correspond to the plurality of function setting buttons BT, respectively, which are provided in the application set items. Inside the group bar SB1, for example, there are four black squares. These four black squares correspond to the four function setting buttons BT11, BT12, BT13, and BT14 provided in the item “Original”. The same applies to the other black squares provided below the button display area BA. These black squares are provided correspondingly to the plurality of function setting buttons BT and in more detail, provided separately for the group bars SB1, SB2, . . . , SB9. Further, these black squares schematically represent the plurality of function setting buttons BT which are virtually arranged in a predetermined (herein, horizontal) direction.

In the setting list screen LG, displayed is the slider SL which can move on the group bars SB in response to a move instruction from the user. The slider SL comprises a frame FR and a tab part TH as shown in FIG. 9. The frame FR is a virtual member surrounding the plurality of black squares inside some group bars SB. The tab part TH is a virtual member to be pressed by a finger or the like of the user.

In an initial state (where the setting list screen LG is being displayed), the slider SL is placed at the leftmost position (the left end of the slider SL is a position P0) in a movable area. Then, the frame FR of the slider SL surrounds the four black squares in the group bar SB1, the three black squares in the group bar SB2, and the left first black square in the group bar SB3.

The plurality of black squares surrounded by the frame FR correspond to some of the function setting buttons BT, which are displayed in the button display area BA, respectively. Therefore, in the above initial state, the eight function setting buttons BT (BT11 to BT14, BT21 to BT23, and BT31) corresponding to the black squares surrounded by the frame FR, respectively, are displayed as the display target buttons in the button display area BA. In other words, the frame FR indicates the display target range for some of the plurality of function setting buttons BT to be displayed in the button display area BA as the display target buttons.

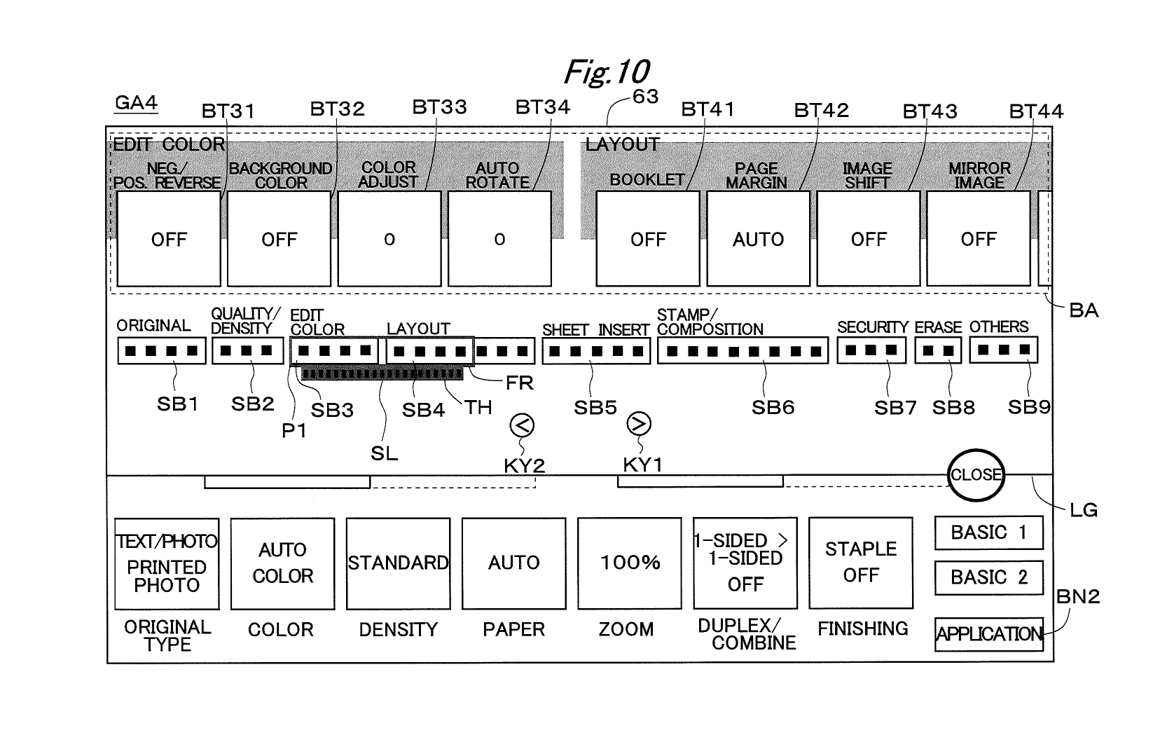

As discussed above, the slider SL moves on the group bars SB in response to the move instruction input from the user. For example, as the user gradually moves (slides) the slider SL towards a position shown in FIG. 10 (the left end of the slider SL is a position P1) by using the tab part TH, some of the function setting buttons BT being displayed are scrolled (gradually moved) leftwards.

Specifically, when the slider SL starts moving rightwards, first, the leftmost black square in the group bar SB1 goes out of the frame FR, and the left second black square in the group bar SB3 goes into the frame FR, to be surrounded. Then, the eight function setting buttons BT (BT12 to BT14, BT21 to BT23, and BT31 to BT32) corresponding to the black squares surrounded by the frame FR, respectively, are displayed as new display target buttons in the button display area BA.

Further, when the slider SL moves rightwards, the left second black square in the group bar SB1 goes out of the frame FR, and the left third black square in the group bar SB3 goes into the frame FR, to be surrounded. Then, the eight function setting buttons BT (BT13 to BT14, BT21 to BT23, and BT31 to BT33) corresponding to the black squares surrounded by the frame FR, respectively, are displayed as new display target buttons in the button display area BA.

Thus, when the slider SL gradually moves rightwards, the black squares to be surrounded by the frame FR of the slider SL are changed and the display target buttons to be displayed in the button display area BA are also changed.

Finally, when the slider SL reaches the position shown in FIG. 10, the frame FR of the slider SL surrounds the four black squares in the group bar SB3 and the four black squares in the group bar SB4. Then, the eight function setting buttons BT (BT31 to BT34, and BT41 to BT44) corresponding to these black squares, respectively, are displayed as the display target buttons in the button display area BA (see FIG. 10).

Thus, the slider SL serves as an operation member (instruction input part) which receives an instruction input (referred to also as a “scroll instruction input”) for giving an instruction for an operation of virtually moving the display target range of some of the function setting buttons BT to be displayed in the button display area BA in the horizontal direction to change the display target buttons (in short, a scroll operation).

Further, in the setting list screen LG, displayed are the move instruction input key KY1 and the move instruction input key KY2.

The move instruction input key KY1 receives a scroll instruction input for causing the display target range of some of the function setting buttons BT to be displayed in the button display area BA to move rightwards. When the user presses the move instruction input key KY1, some of the function setting buttons BT in the button display area BA are scrolled leftwards by a certain amount (e.g., by seven function setting buttons BT), and another some of the function setting buttons BT, which correspond to the position after moving, are displayed. The function setting buttons BT are scrolled in a direction reverse to the direction in which the display target range moves.

The move instruction input key KY2 receives a scroll instruction input for scrolling in a direction reverse to the direction of the scrolling in the case of the move instruction input key KY1. Specifically, the move instruction input key KY2 receives a scroll instruction input for causing the display target range of some of the function setting buttons BT to be displayed in the button display area BA to move leftwards. When the user presses the move instruction input key KY2, some of the function setting buttons BT in the button display area BA are scrolled rightwards by a certain amount (e.g., by seven function setting buttons BT), and another some of the function setting buttons BT, which correspond to the position after moving, are displayed.

Thus, like the slider SL, the move instruction input key KY1 and the move instruction input key KY2 serve as operation members (instruction input parts) which receive the scroll instruction inputs for giving an instruction for the scroll operation.

After the screen GA3 having the setting list screen LG is displayed, in Step S152 of FIG. 5, it is determined whether or not the setting list screen LG has been displayed by the authenticated user CU. Specifically, with reference to the “Display History of Setting list Screen” recorded in the user authentication data TB, it is determined whether or not the authenticated user CU has displayed this screen. In Step S152, it is determined whether or not the authenticated user CU has displayed this screen before the point in time when the setting list screen LG is displayed in Step S151. For this reason, the information on the “whether or not the user has displayed this screen” is updated in Step S155 after Step S152.

When it is determined that the setting list screen LG has been displayed by the authenticated user CU, the process goes to Step S154. On the other hand, when it is not determined that the setting list screen LG has been displayed by the authenticated user CU, the process goes to Step S153. Specifically, when the setting list screen LG has never been displayed during the operation performed by the authenticated user CU, the process goes to Step S153. In other words, the operation of displaying the setting list screen LG in Step S151 is the first operation of displaying the setting list screen LG during the operation performed by the authenticated user CU, the process goes to Step S153.

In Step S153, the image forming apparatus 1 uses the notification control part 13 to perform a notifying process NP of notifying the authenticated user CU of the presence of the slider SL, the move instruction input key KY1, and the move instruction input key KY2. The notification control part 13 notifies the authenticated user CU of the presence of the slider SL, the move instruction input key KY1, and the move instruction input key KY2 immediately after the setting list screen LG is first displayed on the touch screen 63 during the operation performed by the authenticated user CU.

Specifically, as the notifying process NP for the slider SL, the notification control part 13 causes the slider SL to repeatedly move to and fro in the horizontal direction, to thereby notify the authenticated user CU of the presence of the slider SL. More specifically, while the to-and-fro motion (reciprocating motion) TF of the slider SL is repeated, the notification control part 13 gradually reduces the amount of movement of the slider SL in the to-and-fro motion TF, to thereby notify the authenticated user CU of the presence of the slider SL.

In more detail, the notification control part 13 uses the display control part 12 to first cause the slider SL to perform a to-and-fro motion TF1 in which the slider SL moves from the position of FIG. 9 (the left end of the slider SL is the position P0) to the position of FIG. 10 (the left end of the slider SL is the position P1) and then returns (moves back) from the position P1 to the position P0.

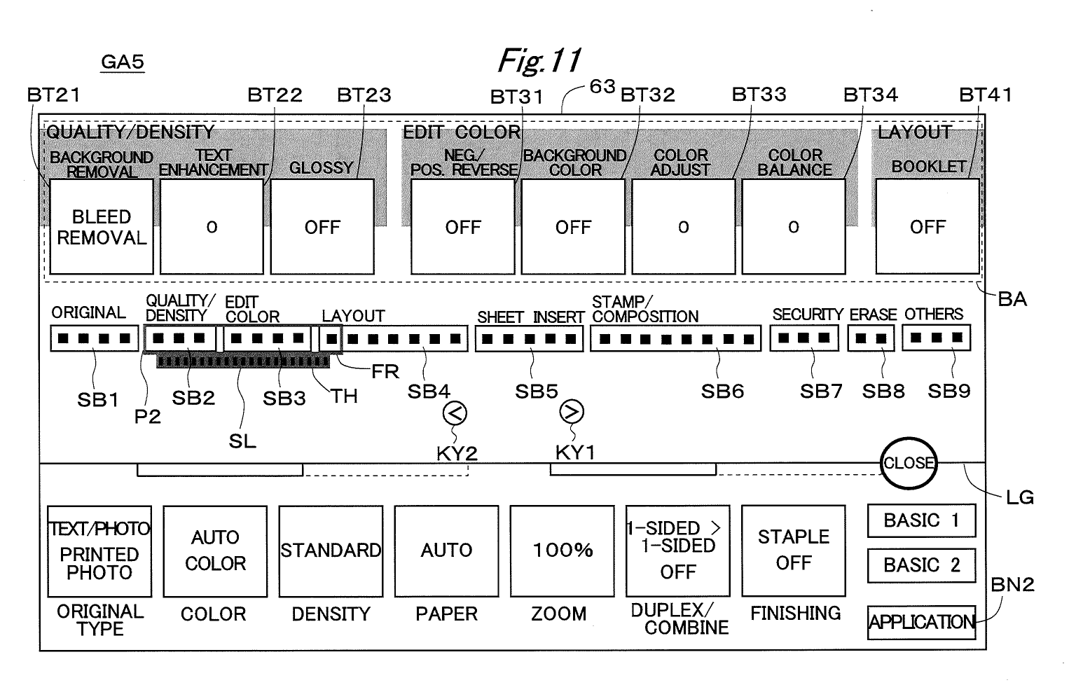

After the to-and-fro motion TF1 is completed, the notification control part 13 uses the display control part 12 to cause the slider SL to perform a to-and-fro motion TF2 in which the slider SL moves from the position of FIG. 9 (the left end of the slider SL is the position P0) to a position of FIG. 11 (the left end of the slider SL is a position P2) and then returns (moves back) from the position P2 to the position P0. As can be seen from comparison between FIGS. 10 and 11, the position P2 is on the left side of the position P1. Therefore, the amount of movement of the slider SL in the to-and-fro motion TF2 is smaller than that in the to-and-fro motion TF1.

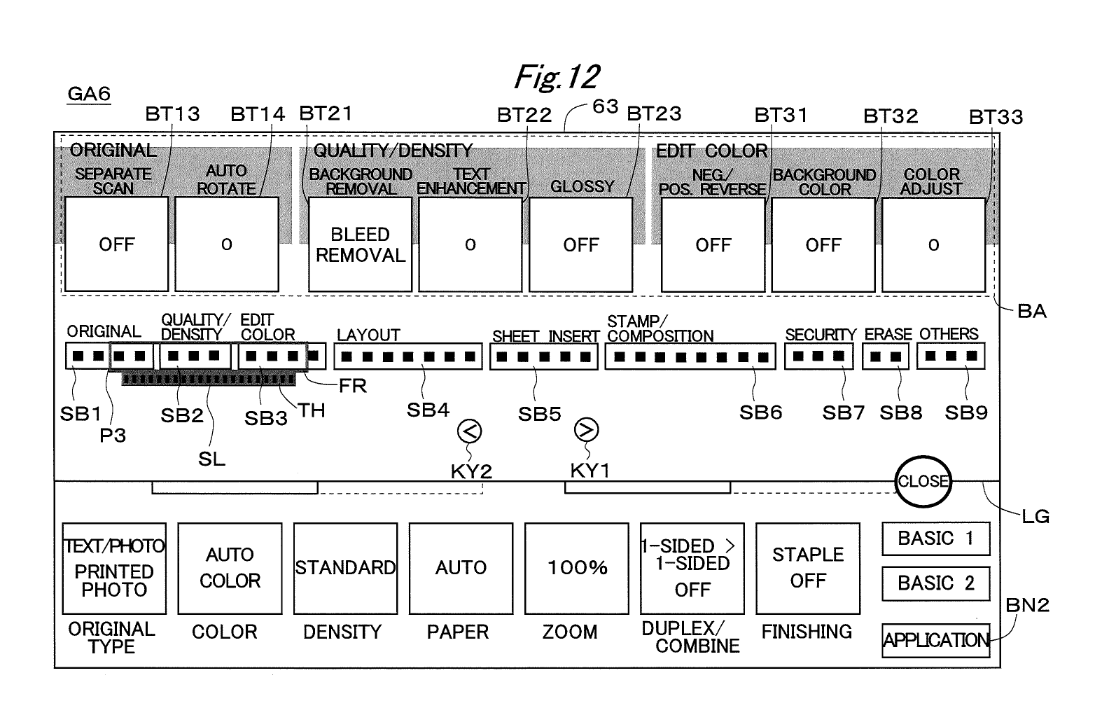

After the to-and-fro motion TF2 is completed, the notification control part 13 uses the display control part 12 to cause the slider SL to perform a to-and-fro motion TF3 in which the slider SL moves from the position of FIG. 9 (the left end of the slider SL is the position P0) to a position of FIG. 12 (the left end of the slider SL is a position P3) and then returns (moves back) from the position P3 to the position P0. As can be seen from comparison between FIGS. 11 and 12, the position P3 is on the left side of the position P2. Therefore, the amount of movement of the slider SL in the to-and-fro motion TF3 is smaller than that in the to-and-fro motion TF2.

Thus, by performing the to-and-fro motions TF1, TF2, and TF3 of the slider SL, the notification control part 13 gradually reduces the amount of movement of the slider SL in the to-and-fro motions TF, to thereby notify the authenticated user CU of the presence of the slider SL.

Some of the function setting buttons BT in the button display area BA are scrolled in conjunction with the movement of the slider SL in the to-and-fro motions TF (TF1, TF2, and TF3).

Further, as the notifying process NP for the move instruction input key KY1 and the move instruction input key KY2, the notification control part 13 also causes at least one (herein, both) of the move instruction input key KY1 and the move instruction input key KY2 to blink.

In more detail, the notification control part 13 uses the display control part 12 to cause the move instruction input key KY1 to blink while the slider SL is moving rightwards in the above to-and-fro motion TF. Further, the notification control part 13 uses the display control part 12 to cause the move instruction input key KY2 to blink while the slider SL is moving leftwards in the above to-and-fro motion TF.

Thus, the notification control part 13 causes both of the move instruction input key KY1 and the move instruction input key KY2 to blink in conjunction with the above to-and-fro motion TF, to thereby notify the authenticated user CU of the presence of the move instruction input key KY1 and the move instruction input key KY2. Though both of the move instruction input key KY1 and the move instruction input key KY2 blink in this case, this is only one exemplary case. There may be a case where either of the move instruction input key KY1 and the move instruction input key KY2 blinks. For example, only the move instruction input key KY1 may blink in the to-and-fro motion TF of the slider SL.

As discussed above, when it is determined in Step S152 that the setting list screen LG has never been displayed during the operation performed by the authenticated user CU, the notification control part 13 notifies the authenticated user CU of the presence of the slider SL, the move instruction input key KY1, and the move instruction input key KY2 immediately after the setting list screen LG is first displayed on the touch screen 63 during the operation performed by the authenticated user CU (Step S153).

After the notifying process NP is completed, the image forming apparatus 1 starts the measurement of a no-operation time TM in Step S154.

In Step S155, the image forming apparatus 1 updates the “Display History of Setting list Screen” (see FIG. 2) associated with the authenticated user CU to “Yes”. Specifically, when “No” is recorded in the “Display History of Setting list Screen” associated with the authenticated user CU, the image forming apparatus 1 updates the “Display History of Setting list Screen” to “Yes”. On the other hand, when “Yes” is recorded in the “Display History of Setting list Screen” associated with the authenticated user CU, the image forming apparatus 1 does not update the “Display History of Setting list Screen”.

After the “Display History of Setting list Screen” is updated, the process returns to Step S13 (see FIG. 3).

In Step S13, when it is determined that the operation input from the user is received, the process goes to Step S14, and the Step S14 and the following steps are performed. On the other hand, when it is not determined that the operation input from the user is received, the process goes to Step S18.

In Step S18, as discussed above, when it is determined that the no-operation time TM is less than a predetermined time, the process returns to Step S13. At the point in time, the measurement of the no-operation time TM has already started in Step S154, and when it is determined that the no-operation time TM is not less than a predetermined time (e.g., 5 seconds), the process goes to Step S19.

Specifically, the determination processes of Steps S13 and S18 are repeated until the operation input from the user is received or until the no-operation time TM becomes not less than the predetermined time. In other words, the image forming apparatus 1 goes into a state for waiting for the operation input from the user or a state (referred to also as a “standby state WS3”) for waiting for the elapse of the predetermined time as the no-operation time TM.

In the above standby state WS3, when it is determined that the no-operation time TM is not less than the predetermined time, the process goes to Step S19. When the predetermined time (in detail, 5 seconds) elapsed without receiving any operation input from the authenticated user CU from the time when the previous notifying process NP is performed in Step S153, for example, the process goes to Step S19. Also when the predetermined time (in detail, 5 seconds) elapsed without receiving any operation input from the authenticated user CU from the time when the previous notifying process NP is performed in Step S192 (described later), the process goes to Step S19 again.

In Step S19, the image forming apparatus 1 performs a process in a case where a predetermined no-operation time TM elapsed.

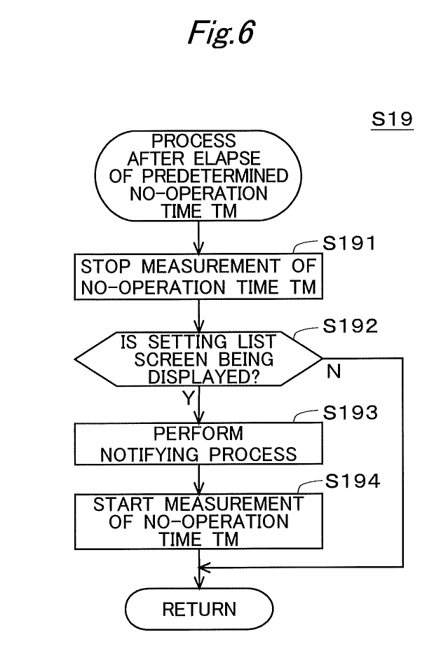

Specifically, the image forming apparatus 1 performs an operation of the flowchart of FIG. 6.

The image forming apparatus 1 first stops the measurement of the no-operation time TM and initializes the no-operation time TM (Step S191).

Next, it is determined whether or not the setting list screen LG is being displayed on the touch screen 63 (Step S192). When it is determined that the setting list screen LG is being displayed, the process goes to Step S193, and when it is not determined that the setting list screen LG is being displayed, the process returns to Step S13 (see FIG. 2).

In Step S193, the image forming apparatus 1 performs the same notifying process NP as the above-discussed notifying process NP (Step S153 in FIG. 5).

In Step S194, the image forming apparatus 1 starts the measurement of the no-operation time TM again.

After the measurement of the no-operation time TM is started, the process returns to Step S13 (see FIG. 2) and the image forming apparatus 1 goes into the standby state WS3.

Thus, when the predetermined time (in detail, 5 seconds) elapsed without receiving any operation input from the authenticated user CU from the time when the notifying operation is performed in the previous notifying process NP (for example, in Step S153), the notification control part 13 performs a new notifying operation of notifying the authenticated user CU of the presence of the slider SL and the like.

Through the above operation, since the user is notified of the presence of the slider SL by performing the to-and-fro motion of the slider SL in the horizontal direction in the notifying process NP, it is possible to cause the authenticated user CU to notice the presence of the slider SL.

As shown in FIG. 9, especially, in a case where the function setting buttons BT are placed within the list display area LG without any one function setting button BT being separated by the boundary of the list display area LG, it is hard to notice that the area can be scrolled. Even in such a case, by notifying the user of the presence of slider SL as discussed above, it is possible to cause the user to notice that a scroll operation can be performed by using the slider SL.

Further, since the user is notified of the presence of the slider SL by performing the to-and-fro motion of the slider SL in the horizontal direction repeatedly (three times), it is possible to cause the authenticated user CU to surely notice the presence of the slider SL.

Furthermore, in the notifying process NP, at least one of the move instruction input key KY1 and the move instruction input key KY2 blinks. Therefore, it is possible to cause the authenticated user CU to notice the presence of the move instruction input key KY1 and the move instruction input key KY2.

When the setting list screen LG has never been displayed during the operation performed by the authenticated user CU, the notifying process NP is performed immediately after the setting list screen LG is first displayed on the touch screen 63 (Steps S152 and S153 in FIG. 5). Therefore, it is possible to cause the authenticated user CU who does not notice the presence of the slider SL, the move instruction input key KY1 or the move instruction input key KY2 to notice the presence. Especially, the user who has not displayed the setting list screen LG probably does not notice the presence of the slider SL, the move instruction input key KY1 or the move instruction input key KY2. Therefore, performing the notifying process NP for the authenticated user CU who has not displayed the setting list screen LG is very effective.

When a predetermined time elapsed without receiving any operation input from the authenticated user CU from the time when the notifying operation is performed in the previous notifying process NP, performed is a new notifying operation of notifying the authenticated user CU of the presence of the slider SL, the move instruction input key KY1 and the move instruction input key KY2. Therefore, it is possible to cause the user who does not notice the presence of the slider SL, the move instruction input key KY1 or the move instruction input key KY2 to notice the presence.

<3. Variations>

Though the preferred embodiment of the present invention has been discussed above, the present invention is not limited to the above-discussed preferred embodiment, but allows various variations without departing from the scope of the present invention.

For example, though the amount of movement rightwards (the amount of movement in one direction) is equal to the amount of movement leftwards (the amount of movement in the reverse direction) in each to-and-fro motion TF (TF1, TF2, TF3) in the above-discussed preferred embodiment, this is only one exemplary case, and the amount of movement rightwards and the amount of movement leftwards may be different. For example, the amount of movement of the slider SL rightwards may be larger than the amount of movement of the slider SL leftwards.

In more detail, in the to-and-fro motion TF1, the notification control part 13 may cause the slider SL to move from the position of FIG. 9 (the left end of the slider SL is the position P0) to the position of FIG. 10 (the left end of the slider SL is the position P1) and then move back from the position P1 to the position of FIG. 12 (the left end of the slider SL is the position P3). Thus, the amount of movement rightwards (P1-P0) may be larger than the amount of movement leftwards (P1-P3).

Further, though the reciprocation in the to-and-fro motion TF are repeated a plurality of times (three times) in the above-discussed preferred embodiment, this is only one exemplary case, and the reciprocation may be performed only once. Alternatively, the reciprocation may be performed for a predetermined time period (e.g., 4 seconds).

Furthermore, though the amount of movement of the slider SL in the repeated to-and-fro motion TF is gradually reduced in the above-discussed preferred embodiment, this is only one exemplary case, and the amount of movement may be constant or may be gradually increased.

Though the slider SL moves from the position of FIG. 9 (the left end of the slider SL is the position P0) to the position of FIG. 10, 11, or 12 (the left end of the slider SL is the position P1, P2, or P3) in the to-and-fro motion TF1, TF2, or TF3 in the above-discussed preferred embodiment, this is only one exemplary case. For example, the slider SL may repeat a to-and-fro motion between the position of FIG. 9 (the left end of the slider SL is the position P0) and a position slightly away therefrom rightwards (e.g., by about 1 mm). Since the slider SL repeatedly moves a very short distance, the slider SL seems to oscillate. Therefore, with this oscillation of the slider SL, it is possible to cause the user to notice the presence of the slider SL.

Though the to-and-fro motion TF of the slider SL is repeated as the notifying process NP in the above-discussed preferred embodiment, this is only one exemplary case, and the slider SL may blink.

Though the notifying process NP for the move instruction input key KY1 and the move instruction input key KY2 is performed in conjunction with the notifying process NP for the slider SL in the above-discussed preferred embodiment, this is only one exemplary case, and the notifying process NP for the move instruction input key KY1 and the move instruction input key KY2 may be performed separately from the notifying process NP for the slider SL. There may be a case, for example where after the notifying process NP for slider SL is performed, the notifying process NP for the move instruction input key KY1 and the move instruction input key KY2 is performed. There may be another case where after the notifying process NP for the move instruction input key KY1 and the move instruction input key KY2 is performed, the notifying process NP for slider SL is performed.

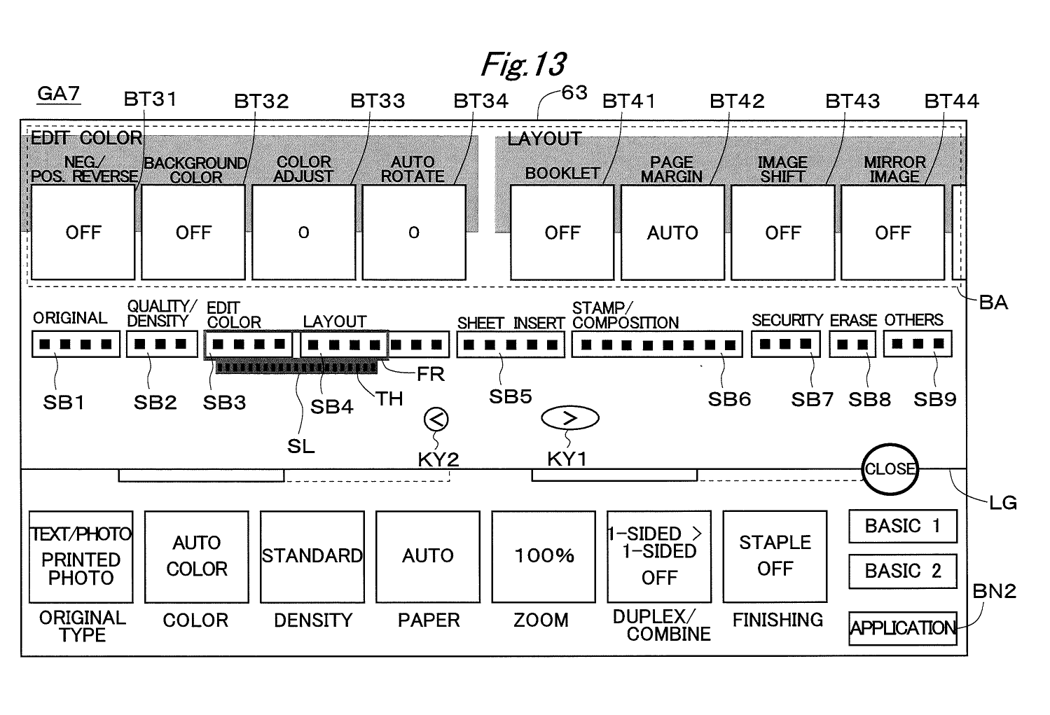

Further, though the move instruction input key KY1 and the move instruction input key KY2 blink in the notifying process NP in the above-discussed preferred embodiment, this is only one exemplary case. For example, at least one of the move instruction input key KY1 and the move instruction input key KY2 may be transformed and displayed. Specifically, as shown in FIG. 13, the notification control part 13 may use the display control part 12 to change a shape of the move instruction input key KY1 from a circle to an ellipse.

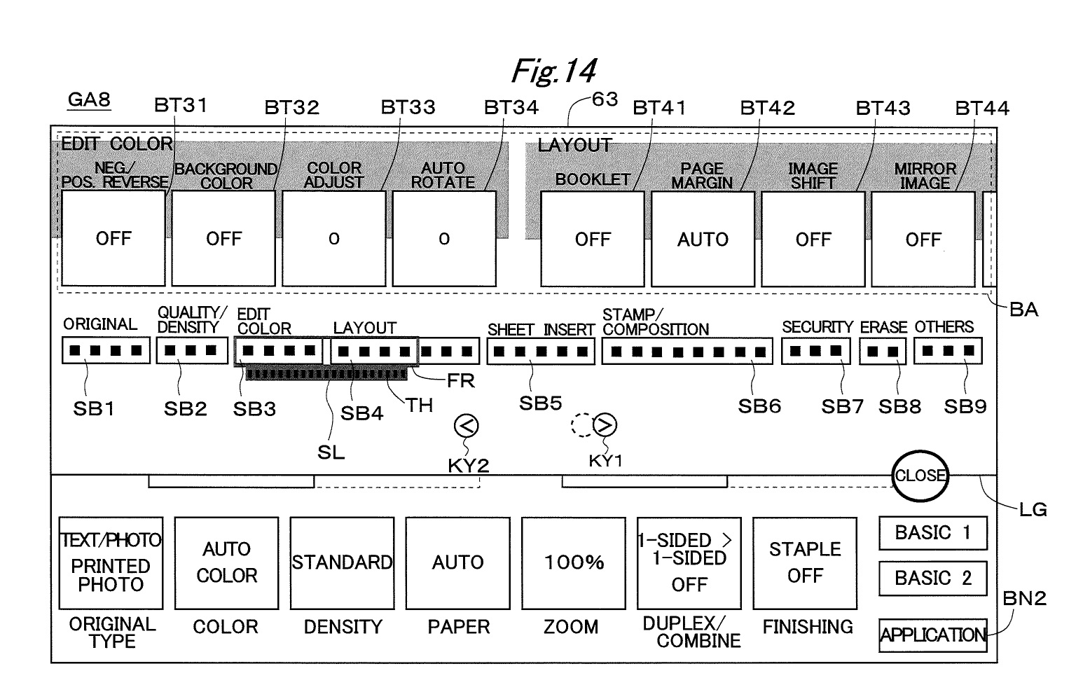

Alternatively, at least one of the move instruction input key KY1 and the move instruction input key KY2 may be moved in a predetermined direction. For example, as shown in FIG. 14, the notification control part 13 may use the display control part 12 to move the move instruction input key KY1 rightwards by a certain amount (e.g., by one move instruction input key KY1).

Further alternatively, at least one of the move instruction input key KY1 and the move instruction input key KY2 may be repeatedly moved to and fro on the touch screen 63. For example, the move instruction input key KY1 may repeatedly perform a to-and-fro motion in which the move instruction input key KY1 moves slightly rightwards (e.g., by about 1 mm) from an initial position and then moves back to the initial position. In this case, since the move instruction input key KY1 repeatedly moves a very short distance, the move instruction input key KY1 seems to oscillate.

Through the notifying process NP is performed to produce a visual effect in the above-discussed preferred embodiment and the above variations, this is only one exemplary case, and the notifying process NP may be performed to additionally produce an auditory effect.

For example, the notification control part 13 may use an audio output part in the image forming apparatus 1 to produce a predetermined sound effect in the notifying process NP.

In this case, since a predetermined sound effect is outputted while the notifying process NP is performed, even when the authenticated user CU takes his eyes off the touch screen 63, it is possible to give the user a cue to direct his attention to the touch screen 63.

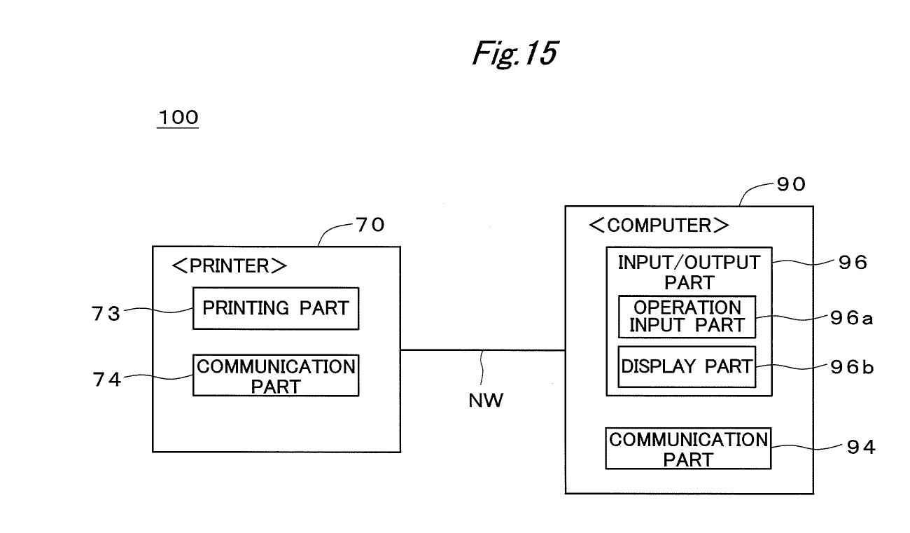

Though the idea of the present invention is applied to an image forming system formed of a single image forming apparatus 1 in the above-discussed preferred embodiment, this is only one exemplary case. The idea of the present invention may be applied to, for example, an image forming system formed of a plurality of apparatuses (e.g., a computer and a printer) as show in FIG. 15.

FIG. 15 is a schematic view showing a constitution of an image forming system 100 in accordance with this variation. The image forming system 100 comprises a printer 70 and a computer 90.

The printer 70 is connected to the computer 90 through the network NW and can transmit and receive data to/from the computer 90. The network NW includes a LAN (Local Area Network) and various networks such as the internet.

The printer 70, especially, serves as a printing device for performing a print job from the computer 90. Specifically, the computer 90 sends a print job to the printer 70 through a printer driver (software program) PG2 or the like which is installed therein. On the other hand, the printer 70 receives the print job sent from the computer 90 and executes the print job. With this operation, the printer 70 performs a printing process.

Specifically, as shown in FIG. 15, the printer 70 comprises a printing part 73, a communication part 74, and the like. The printing part 73 and the communication part 74 are processing parts which perform the same operations as the printing part 3 and the communication part 4 of FIG. 1 do, respectively.

the computer 90 is a personal computer and comprises an input/output part 96, a communication part 94, and the like. The input/output part 96 has an operation input part 96a for receiving an input which is given to the computer 90 and a display part 96b for displaying various information thereon. For example, a keyboard, a mouse, and the like are provided as the operation input part 96a, and a liquid crystal display and the like are provided as the display part 96b. The communication part 94 is a processing part which performs the same operation as the communication part 4 of FIG. 1 does.

In the image forming system 100, the computer 90 implements the above idea by using the printer driver PG2. Specifically, the computer 90 can display a setting list screen LG relevant to the printer 70 on the display part 96b by executing the printer driver PG2. In more detail, by executing the printer driver PG2, processing parts which are the same as the user authentication part 11, the display control part 12, the notification control part 13, the input control part 14, and the like are implemented in the computer 90, and by using the processing parts 11, 12, 13, 14, and the like, the same operations relating to the display on the display part 96b, and the like, as discussed in the preferred embodiment and the like are performed. The printer driver PG2 may be acquired via various portable (in other words, non-transitory) computer-readable recording media (a USB memory or the like). Alternatively, the printer driver PG2 may be downloaded via the network or the like and installed into the computer 90.

In more detail, the computer 90 displays some of a plurality of function setting buttons BT, which are included in a display target range, as display target buttons on the display part 96b.

The computer 90 also performs the above-discussed notifying process NP on the display part 96b.

The same applies to the other operations. Relating to the display on the display part 96b, performed are the same operations as the above-discussed operations relating to the display on the touch screen 63.

In such an aspect of the variation, the same effect as that of the above-discussed preferred embodiment and the like can be produced.

While the invention has been shown and described in detail, the foregoing description is in all aspects illustrative and not restrictive. It is therefore understood that numerous modifications and variations can be devised without departing from the scope of the invention.

What is claimed is:

1. An image forming system, comprising:
a display control part for displaying at least one of a plurality of buttons, which is included in a display target range, on a display part as display target buttons, said plurality of buttons corresponding to a plurality of functions, respectively, being virtually arranged in a predetermined direction;
an instruction input part for receiving a scroll instruction input for causing said display target range to virtually move in said predetermined direction to change said display target buttons; and
a notification control part for controlling a notifying operation for notifying a user of the presence of said instruction input part.

2. The image forming system according to claim 1, wherein
said instruction input part is displayed on said display part and has a slider for receiving said scroll instruction input, and
said notification control part causes said slider to move in said predetermined direction on said display part, to thereby notify said user of the presence of said instruction input part.

3. The image forming system according to claim 2, wherein
said notification control part causes said slider to move to and fro in said predetermined direction on said display part, to thereby notify said user of the presence of said instruction input part.

4. The image forming system according to claim 3, wherein
said notification control part causes said slider to repeatedly move to and fro in said predetermined direction on said display part, to thereby notify said user of the presence of said instruction input part.

5. The image forming system according to claim 4, wherein
said notification control part gradually reduces the amount of movement of said slider in a to-and-fro motion while said to-and-fro motion of said slider is repeated.

6. The image forming system according to claim 3, wherein
the amount of movement in one direction is equal to that in a reverse direction in said to-and-fro motion.

7. The image forming system according to claim 1, wherein
said instruction input part is displayed on said display part and has a slider for receiving said scroll instruction input, and
said notification control part causes said slider to blink.

8. The image forming system according to claim 1, wherein
said instruction input part has:
a first instruction key displayed on said display part and used for causing said display target range to move in a first direction; and
a second instruction key displayed on said display part and used for causing said display target range to move in a second direction reverse to said first direction, and
said notification control part causes at least one of said first instruction key and said second instruction key to move in said predetermined direction on said display part.

9. The image forming system according to claim 8, wherein
said notification control part causes at least one of said first instruction key and said second instruction key to repeatedly move to and fro in said predetermined direction on said display part.

10. The image forming system according to claim 1, wherein
said instruction input part has:
a first instruction key displayed on said display part and used for causing said display target range to move in a first direction; and
a second instruction key displayed on said display part and used for causing said display target range to move in a second direction reverse to said first direction, and
said notification control part causes at least one of said first instruction key and said second instruction key to blink.

11. The image forming system according to claim 1, wherein
said instruction input part has:
a first instruction key displayed on said display part and used for causing said display target range to move in a first direction; and
a second instruction key displayed on said display part and used for causing said display target range to move in a second direction reverse to said first direction, and
said notification control part changes a shape of at least one of said first instruction key and said second instruction key to be displayed.

12. The image forming system according to claim 1, wherein
said notification control part performs a new notifying operation for notifying said user of the presence of said instruction input part after a predetermined time elapses without receiving any operation input from a user from a time when a previous notifying operation is performed.

13. The image forming system according to claim 1, further comprising:
a user authentication part for performing user authentication; and
a recording part for recording whether or not a setting list screen including said display target buttons has been displayed on said display part during an operation performed by an authenticated user who is authenticated by said user authentication part,
wherein said notification control part notifies said user of the presence of said instruction input part immediately after said setting list screen is first displayed on said display part during said operation performed by said authenticated user when said setting list screen has never been displayed during said operation performed by said authenticated user.

14. A non-transitory computer-readable recording medium recording therein a computer program for causing a computer to serve as a device comprising:
a display control part for displaying at least one of a plurality of buttons, which is included in a display target range, on a display part as display target buttons, said plurality of buttons corresponding to a plurality of functions, respectively, being virtually arranged in a predetermined direction;
an instruction input part for receiving a scroll instruction input for causing said display target range to virtually move in said predetermined direction to change said display target buttons; and
a notification control part for notifying a user of the presence of an operation member displayed on said display part and used for receiving said scroll instruction input.

15. The recording medium according to claim 14, wherein
said instruction input part is displayed on said display part and has a slider for receiving said scroll instruction input, and
said notification control part causes said slider to move in said predetermined direction on said display part, to thereby notify said user of the presence of said instruction input part.

16. The recording medium according to claim 14, wherein
said instruction input part is displayed on said display part and has a slider for receiving said scroll instruction input, and
said notification control part causes said slider to blink.

17. The recording medium according to claim 14, wherein
said instruction input part has:
a first instruction key displayed on said display part and used for causing said display target range to move in a first direction; and
a second instruction key displayed on said display part and used for causing said display target range to move in a second direction reverse to said first direction, and
said notification control part causes at least one of said first instruction key and said second instruction key to move in said predetermined direction on said display part.

18. The recording medium according to claim 14, wherein
said instruction input part has:
a first instruction key displayed on said display part and used for causing said display target range to move in a first direction; and
a second instruction key displayed on said display part and used for causing said display target range to move in a second direction reverse to said first direction, and
said notification control part causes at least one of said first instruction key and said second instruction key to blink.

19. The recording medium according to claim 14, wherein
said notification control part performs a new notifying operation for notifying said user of the presence of said instruction input part after a predetermined time elapses without receiving any operation input from a user from a time when a previous notifying operation is performed.

20. The recording medium according to claim 14, wherein
said computer program causes said computer to serve as a device further comprising:
a user authentication part for performing user authentication; and
a recording part for recording whether or not a setting list screen including said display target buttons has been displayed on said display part during an operation performed by an authenticated user who is authenticated by said user authentication part,
wherein said notification control part notifies said user of the presence of said instruction input part immediately after said setting list screen is first displayed on said display part during said operation performed by said authenticated user when said setting list screen has never been displayed during said operation performed by said authenticated user.
